(19) United States
(12) Patent Application Publication
(10) Pub. No.: US 2008/0026195 A1
(43) Pub. Date: Jan. 31, 2008

(54) Polyimide composite flexible board and its preparation field of the invention

(75) Inventors: Kuen Yuan Hwang, Hsinchu (TW); An Pang Tu, Hsinchu (TW); Sheng Yen Wu, Hsinchu (TW); Te Yu Lin, Hsinchu (TW)

Correspondence Address: BIRCH STEWART KOLASCH & BIRCH, PO BOX 747, FALLS CHURCH, VA, 22040-0747, US

(73) Assignee: CHANG CHUN PLASTICS CO., LTD.

(21) Appl. No.: 11/653,957

(22) Filed: Jan. 17, 2007

(30) Foreign Application Priority Data
Jul. 26, 2006 (TW) 095127281

(51) Int. Cl. B32B 15/08; B32B 15/20

(52) U.S. Cl. 428/213; 428/458; 428/473.5; 264/171.17; 264/171.23; 264/331.19

(57) ABSTRACT

The present invention relates to a polyimide composite flexible board and a process for preparing the same. The process comprises sequentially applying polyamic acids each having a glass transition temperature of from 280 to 300° C., from 300 to 350° C., and from 190 to 280° C. after imidization on a metal foil, subsequently subjecting the polyamic acids to imidization into polyimide by heating, and then pressing the polyimide-containing metal foil with a metal foil under high temperature to produce a two-metal-side printed circuit flexible board.

According to the present invention, it can obtain a polyimide composite flexible board having an excellent mechanical property, high heat resistance, and excellent dimension stability without using an adhering agent.

### FIELD OF THE INVENTION

The present invention relates to a polyimide composite flexible board and a process preparing the same.

### BACKGROUND OF THE INVENTION

Aromatic polyimide film has been widely used in various technical fields because it exhibits excellent high-temperature resistance, outstanding chemical properties, high insulation, and high mechanical strength. For example, aromatic polyimide film is advantageously used in the form of a composite sheet of successive aromatic polyimide film/metal film to produce a flexible printed circuit (FPC), a carrier tape of tape automated bonding (TAB), and a lead-on-chip (LOC) structural tape. Especially, the flexible printed circuit board is broadly applied to materials of laptops, consumer electronic products, and mobile communication equipments.

Heat resistant plastic film such as aromatic polyimide film has been extensively used to laminate with metal foils in the production of printed circuit board. Most known aromatic polyimide film laminated with the metal foils is generally produced by using a thermosetting adhesive to combine the aromatic polyimide film with the metal foils together. A two-side flexible circuit board is mainly produced by applying the thermosetting adhesive such as epoxy resin or acrylic-based resin to both sides of polyimide film, and then removing a solvent through an oven to make the adhesive become Stage-B which is an intermediate stage during the reaction of the thermosetting resin, and subsequently laminating the upper and lower sides of the polyimide film with copper foils or the metal foils through heating and pressing, and finally putting the polyimide-containing foil in a high temperature oven to conduct thermosetting to Stage-C which is a final stage during the reaction of the thermosetting resin.

Nevertheless, the thermosetting adhesive is commonly deficient in the heat resistance and can only keep its adhesion under the temperature not more than 200° C. Therefore, most known adhesive cannot be used to produce composite film that needs high temperature treatment, for example, a printed circuit flexible board that needs weld or needs to be used under high temperature. To achieve heat resistance and flam retardance as required, the thermosetting resin used is halogen-containing flame resistant and bromine-containing resin or halogen-free phosphorus-containing resin. However, the halogen-containing thermosetting resin can generate toxic dioxins during burning which seriously pollute environment. Furthermore, the flexible board laminated by the thermosetting resin adhesive has high coefficient of thermal expansion, poor heat resistance, and bad dimension stability.

To overcome the above disadvantages of the flexible board produced by the thermosetting adhesive, the present inventors apply various polyamic acids as polyimide precursors to a metal foil, and then subject the polyamic acids to imidization by heating, and finally press the polyimide-containing metal foil with a metal foil under high temperature to obtain a halogen-free and phosphorus-free flexible board having high adhesion, high heat resistance, and excellent dimension stability. Thus the present invention is completed.

### BRIEF DESCRIPTION OF THE INVENTION

The present invention relates to a process for preparing a polyimide composite flexible board which comprises sequentially applying polyamic acids each having a glass transition temperature (Tg) of from 280 to 300° C., from 300 to 350° C., and from 190 to 280° C. after imidization on a metal foil, subsequently subjecting the polyamic acids to imidization into polyimide by heating, and then pressing the polyimide-containing metal foil with a metal foil under high temperature to produce a two-metal-side printed circuit flexible board.

According to the present invention, it can obtain a polyimide composite flexible board having an excellent mechanical property, high heat resistance, and excellent dimension stability without using an adhering agent.

According to the process for preparing the polyimide composite flexible board of the present invention, a metal foil such as a copper foil is firstly applied with a polyamic acid resin (a) having a high Tg after imidization in order to provide the metal foil with high adhesion and raise the Tg of the obtained polyimide composite flexible board, and then applied with a polyamic acid resin (b) having a higher Tg after imidization in order to provide the obtained polyimide composite flexible board with an excellent mechanical property and electrical property, and finally applied with a polyamic acid resin (c) having a lower Tg after imidization in order to provide the metal foil with easily process lamination and high adhesion.

The present invention thus provides a process for preparing a polyimide composite flexible board which comprises the following steps of:
(a) applying the first polyamic acid resin having a glass transition temperature of from 280 to 300° C. after imidization on a metal foil, which is subsequently in an oven heated at a temperature of 90 to 140° C. and then of 150 to 200° C. to remove a solvent;
(b) taking out the polyamic-acid-applied metal foil that has removed the solvent, following by applying the second polyamic acid resin having a glass transition temperature of from 300 to 350° C. after imidization on the first polyamic acid layer, which is subsequently in an oven heated at a temperature of 90 to 140° C. and then of 150 to 200° C. to remove a solvent;
(c) taking out the applied metal foil, following by applying the third polyamic acid resin having a glass transition temperature of from 190 to 280° C. after imidization on the second polyamic acid layer, which is subsequently in an oven heated at a temperature of 90 to 140° C. and then of 150 to 200° C. to remove a solvent;
(d) into a nitrogen gas oven putting the obtained metal foil with three layers of polyamic acids, which is then sequentially heated at a temperature of 160 to 190° C., 190 to 240° C., 270 to 320° C. and 330 to 370° C. to subject the polyamic acids to imidization; and
(e) taking out the polyimide-containing metal foil after cooling, which is then laminated with another metal foil under a temperature of from 320 to 370° C. and a pressure of from 10 to 200 Kgf by using a pressing machine or a roll calender to produce a two-side polyimide composite flexible board.

The present invention further provides a polyimide composite flexible board made by sequentially laminating a metal foil, a polyimide thin layer having a glass transition temperature of from 280 to 300° C., a polyimide thin layer having a glass transition temperature of from 300 to 350° C., a polyimide thin layer having a glass transition temperature of from 190 to 280° C., and a metal foil.

### BRIEF DESCRIPTION OF FIGURES

FIG. 1 is a flow chart illustrating a commercial production of two-side flexible printed circuit board pressed with metal foils.

FIG. 2 is a schematic view of application equipment used in the process of the present invention.

FIG. 3 is a schematic view of imidization equipment used in the process of the present invention.

FIG. 4 is a schematic view of pressing equipment used in the process of the present invention.

### DETAILED DESCRIPTION OF THE INVENTION

In the process for preparing the polyimide composite flexible board of the present invention, a polyamic acid resin is obtained by reacting diamine of the following formula (I),

H₂N—R₁—NH₂ (I)

[wherein R₁ is phenylene (-Ph-); -Ph-X-Ph- wherein X represents a covalent bond, C₁₋₄ alkylene which may be substituted with a halogen(s), —O-Ph-O—, —O—, —CO—, —S—, —SO—, or —SO₂—; C₂₋₁₄ aliphatic hydrocarbon group; C₄₋₃₀ aliphatic cyclic hydrocarbon group; C₆₋₃₀ aromatic hydrocarbon group; or -Ph-O—R₂—O-Ph- wherein R₂ represents -Ph- or -Ph-X-Ph-, and X represents a covalent bond, C₁₋₄ alkylene which may be substituted with a halogen(s), —O-Ph-O—, —O—, —CO—, —S—, —SO—, or —SO₂—]; with dianhydride of the following formula (II),

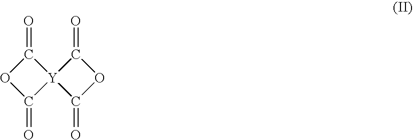

[wherein Y is a aliphatic group containing 2 to 12 carbon atoms; a cycloaliphatic group containing 4 to 8 carbon atoms; monocyclic or polycyclic C₆₋₁₄ aryl; >Ph-X-Ph< wherein X represents a covalent bond, C₁₋₄ alkylene which may be substituted with a halogen(s), —O-Ph-O—, —O—, —CO—, —S—, —SO—, or —SO₂—].

In the process for preparing the polyimide composite flexible board of the present invention, the first polyamic acid resin having a glass transition temperature of from 280 to 300° C. after imidization is obtained by reacting a diamine monomer containing one benzene ring and a dianhydride moner containing one benzene ring with other diamine monomer and other dianhydride monomer, under the conditions that the mole ratio of total diamine monomer/total dianhydride monomer ranges from 0.5 to 2.0, preferably from 0.75 to 1.25, and the mole ratio of diamine monomer containing one benzene ring/other diamine monomer ranges from 60/40 to 20/80, and the mole ratio of dianhydride monomer containing one benzene ring/other dianhydride monomer ranges from 40/60 to 20/80.

In the process of the present invention, the second polyamic acid resin having a glass transition temperature of from 300 to 350° C. after imidization is obtained by reacting a diamine monomer containing one benzene ring and a dianhydride monomer containing one benzene ring with other diamine monomer and other dianhydride monomer, under the conditions that the mole ratio of total diamine monomer/total dianhydride monomer ranges from 0.5 to 2.0, preferably from 0.75 to 1.25, and the mole ratio of diamine monomer containing one benzene ring/other diamine monomer ranges from 95/5 to 80/20, and the mole ratio of dianhydride monomer containing one benzene ring/other dianhydride monomer ranges from 80/20 to 60/40.

In the process of the present invention, the third polyamic acid resin having a glass transition temperature of from 190 to 280° C. after imidization is obtained by reacting a diamine monomer containing at least two benzene rings and a dianhydride monomer containing two benzene rings with other dianhydride monomer, under the conditions that the mole ratio of total diamine monomer/total dianhydride monomer ranges from 0.5 to 2.0, preferably from 0.75 to 1.25, and the mole ratio of diamine monomer containing at least two benzene rings/other diamine monomer ranges from 60/40 to 100/0.

Embodiments of the dianhydride monomer for preparing the polyamic acid in the present invention is for instance, but not limited to, aromatic dianhydride such as pyromellitic dianhydride (PMDA), 4,4-oxydiphthalic anhydride (ODPA), 3,3′,4,4′-biphenyltetracarboxylic dianhydride (BPDA), 3,3′,4,4′-benzophenonetetracarboxylic dianhydride (BTDA), ethylenetetracarboxylic dianhydride, butanetetracarboxylic dianhydride, cyclopentanetetracarboxylic dianhydride, 2,2′,3,3′-benzophenonetetracarboxylic dianhydride, 2,2′,3,3′-biphenyltetracarboxylic dianhydride, 2,2-bis(3,4-dicarboxyphenyl)propane dianhydride, 2,2-bis(2,3-dicarboxyphenyl)propane dianhydride, bis(3,4-dicarboxyphenyl)ether dianhydride, bis(3,4-dicarboxyphenyl)-sulfone dianhydride, 1,1-bis(2,3-dicarboxyphenyl)ethane dianhydride, bis(2,3-dicarboxyphenyl)methane dianhydride, bis(3,4-dicarboxyphenyl)methane dianhydride, 4,4′-(p-phenylenedioxy)diphthalic dianhydride, 4,4′-(m-phenylenedioxy)diphthalic dianhydride, 2,3,6,7-naphthalene-tetracarboxylic dianhydride, 1,4,5,8-naphthalene-tetra-carboxylic dianhydride, 1,2,5,6-naphthalenetetracarboxylic dianhydride, 1,2,3,4-benzenetetracarboxylic dianhydride, 3,4,9,10-perylenetetracarboxylic dianhydride, 2,3,6,7-anthracene-tetracarboxylic dianhydride, 1,2,7,8-phenanthrenetetracarboxylic dianhydride, etc. The foregoing dianhydrides can be used alone or in combination of two or more. Among these, pyromellitic dianhydride (PMDA), 4,4′-oxy-diphthalic anhydride (ODPA), 3,3′,4,4′-biphenyltetracarboxylic dianhydride (BPDA), and 3,3′,4,4′-benzophenonetetracarboxylic dianhydride (BTDA) are preferable.

Embodiments of the diamine monomer for preparing the polyamic acid in the present invention is for instance, but not limited to, aromatic diamine such as p-phenylene diamine (PDA), 4,4-oxydianiline (ODA), 1,3-bis(4-aminophenoxy)benzene (TPE-R), 1,3-bis(3-aminophenoxy)-benzene (APB), 2,2-bis[4-(4-aminophenoxy)phenyl]propane (BAPP), bis[4-(4-aminophenoxy)phenyl]sulfone (BAPS), 4,4′-bis(4-amino-phenoxy)-3,3′-dihydroxybiphenyl (BAPB), bis[4-(3-aminophenoxy)-phenyl]methane, 1,1-bis[4-(3-aminophenoxy)phenyl]ethane, 1,2-bis[4-(3-aminophenoxy)phenyl]ethane, 2,2-bis[4-(3-aminophenoxy)phenyl]-propane, 2,2′-bis[4-(3-aminophenoxy)phenyl]-butane, 2,2-bis[4-(3-amino-phenoxy)phenyl]-1,1,1,3,3,3-hexafluoropropane, 4,4′-bis(3-amino-phenoxy)biphenyl, bis[4-(3-aminophenoxy)phenyl]ketone, bis[4-(3-aminophenoxy)phenyl]sulfide, bis[4-(3-aminophenoxy)phenyl]-sulfoxide, bis[4-(3-aminophenoxy)phenyl]sulfone, bis[4-(3-aminophenoxy)-phenyl]ether, etc. The foregoing diamines can be used alone or in combination of two or more. Among these, p-phenylene diamine (PDA), 4,4′-oxydianiline (ODA), 1,3-bis(4-amino-phenoxy)benzene (TPE-R), 1,3-bis(3-aminophenoxy)benzene (APB), 2,2-bis[4-(4-aminophenoxy)phenyl]propane (BAPP), bis[4-(4-amino-phenoxy)phenyl]sulfone (BAPS), and 4,4′-bis(4-amino-phenoxy)-3,3′-dihydroxybiphenyl (BAPB) are preferable.

The dianhydrides can react with the diamines in aprotic polar solvents. The aprotic polar solvents are not particularly limited as long as they do not react with reactants and products. Embodiments of the aprotic polar solvents are for instance N,N-dimethylacetamide (DMAc), N-methylpyrrolidone (NMP), N,N-dimethyl-formamide (DMF), tetrahydrofuran (THF), dioxane, chloroform (CHCl₃), dichloromethane, etc. Among these, N-methylpyrrolidone (NMP) and N,N-dimethyl-acetamide (DMAc) are preferable.

The reaction of the dianhydrides and the diamines can be generally conducted in the range of from room temperature to 90° C., preferably from 30 to 75° C. Additionally, the mole ratio of aromatic diamines to aromatic dianhydrides ranges between 0.5 and 2.0, preferably between 0.75 and 1.25. When two or more dianhydrides and diamines are individually used to prepare the polyamic acids, their kinds are not particularly limited but depend on the final use of the polyimides as required.

Preferably, for the first polyamic acid having a glass transition temperature of from 280 to 300° C. after imidization, the used diamines at least include p-phenylene diamine (PDA) and the used dianhydrides at least include pyromellitic dianhydride (PMDA), under the conditions that the mole ratio of p-phenylene diamine monomer/other diamine monomer ranges from 60/40 to 20/80, and the molar ratio of pyromellitic dianhydride monomer/other dianhydride monomer ranges from 40/60 to 20/80.

Preferably, for the second polyamic acid having a glass transition temperature of from 300 to 350° C. after imidization, the used diamines at least include p-phenylene diamine (PDA) and the used dianhydrides at least include pyromellitic dianhydride (PMDA), under the conditions that the mole ratio of p-phenylene diamine monomer/other diamine monomer ranges from 95/5 to 80/20, and the molar ratio of pyromellitic dianhydride monomer/other dianhydride monomer ranges from 80/20 to 60/40.

Preferably, for the third polyamic acid having a glass transition temperature of from 190 to 280° C. after imidization, the used diamines include a diamine monomer containing at least two benzene rings which are selected from at least one group consisting of 2,2-bis[4-(4-aminophenoxy)phenyl]propane (BAPP), bis[4-(4-amino-phenoxy)-phenyl]sulfone (BAPS), 1,3-bis(3-aminophenoxy)benzene (APB), 4,4′-oxydianiline (ODA), and 4,4′-bis-(4-aminophenoxy)-3,3′-dihydroxy-biphenyl (BAPB), and the used dianhydrides include a dianhydride monomer containing two benzene rings which are selected from at least one group consisting of 4,4′-oxydiphthalic dianhydride (ODPA), 3,3′,4,4′-biphenyl-tetracarboxylic dianhydride (BPDA), and 3,3′,4,4′-benzophenonetetracarboxylic dianhydride (BTDA), under the conditions that the mole ratio of diamine monomer containing at least two benzene rings/other diamine monomer ranges from 60/40 to 100/0.

According to the polyimide composite flexible board and its preparation of the present invention, the thickness of the metal foil such as copper foil is not particularly limited but depends on the final use of the obtained composite flexible board. However, the thickness of the metal foil usually ranges from 12 μm to 70 μm, and the thicknesses of the first polyimide thin layer, the second polyimide thin layer, and the third polyimide thin layer individually satisfy the following conditions.

$$\frac{3}{100} \leq \frac{The Thickness of the Frist Polyimide Thin Layer}{The Total Thickness of Three Layers of Polyimides} \leq \frac{35}{100}$$

$$\frac{30}{100} \leq \frac{The Thickness of the Second Polyimide Thin Layer}{The Total Thickness of Three Layers of Polyimides} \leq \frac{94}{100}$$

$$\frac{3}{100} \leq \frac{The Thickness of the Third Polyimide Thin Layer}{The Total Thickness of Three Layers of Polyimides} \leq \frac{35}{100} .$$

The present invention will further illustrate by reference to the following synthesis examples and working examples. However, these synthesis examples and working examples are not intended to limit the scope of the present invention but only describe the present invention.

### EXAMPLES

### Synthesis Example

(a) Synthesis of Polyamic Acid-1

Into a four-neck bottle reactor equipped with a stirrer and a nitrogen gas conduit under the flow rate of nitrogen gas of 20 cc/min, 5.4 g (0.05 mole) of p-phenylene diamine (PDA) was placed and dissolved in N-methylpyrrolidone (NMP). After 15 minutes, 10 g (0.05 mole) 4,4-oxydianiline (ODA) was fed to dissolve and meantime maintained at a temperature of 15° C. 8.82g (0.03 mole) of 3,3′,4,4′-biphenyl-tetracarboxylic dianhydride (BPDA) and 15 g of NMP were fed in the first flask accompanied with a stir bar and then stirred to dissolve. Subsequently, the mixture in the first flask was added to the above reactor that the nitrogen gas was continuously charged and stirred to carry out the reaction for one hour. 16.1 g (0.05 mole) of 3,3′,4,4′-benzophenone-tetracarboxylic dianhydride (BTDA) and 30 g of NMP were fed in the second flask and then stirred to dissolve. Subsequently, the mixture in the second flask was added to the above reactor that the nitrogen gas was continuously charged and stirred to carry out the reaction for one hour. 4.36 g (0.02 mole) of pyromellitic dianhydride (PMDA) and 10 g of NMP were fed in the third flask and then stirred to dissolve. Subsequently, the mixture in the third flask was added to the above reactor that the nitrogen gas was continuously charged and stirred to carry out the reaction for one hour. Afterward, the reaction was carried out at a temperature of 15° C. for further four hours to obtain the polyamic acid (PAA 1-1). 0.5 g of the obtained polyamic acid dissolved in 100 ml of NMP, and at a temperature of 25° C., was measured the intrinsic viscosity (IV) as 0.85 dl/g and the glass transition temperature (Tg) after imidization as 290° C.

According to the ingredients and their amount listed in Table 1, Polyamic Acids (PAA) 1-2 and 1-3 were synthesized by the analogous procedures and measured the intrinsic viscosity (IV) and the glass transition temperature (Tg) after imidization shown in Table 1 as well.

TABLE 1

| | PAA 1-1 | PAA 1-2 | PAA 1-3 |
|---|---|---|---|
| BPDA (mole) | 0.03 | 0.02 | 0.03 |
| BTDA (mole) | 0.05 | 0.06 | 0.05 |
| PMDA (mole) | 0.02 | 0.02 | 0.02 |
| PDA (mole) | 0.05 | 0.05 | 0.06 |
| ODA (mole) | 0.05 | 0.05 | 0.04 |
| Intrinsic Viscosity | 0.85 | 0.93 | 0.97 |
| (IV) (dl/g) | | | |
| Tg (° C.) | 290 | 285 | 297 |

(b) Synthesis of Polyamic Acid-2

Into a four-neck bottle reactor equipped with a stirrer and a nitrogen gas conduit under the flow rate of nitrogen gas of 20 cc/min, 9.72 g (0.09 mole) of p-phenylene diamine (PDA) was placed and dissolved in N-methylpyrrolidone (NMP). After 15 minutes, 2 g (0.01 mole) 4,4′-oxydianiline (ODA) was fed to dissolve and meantime maintained at a temperature of 15° C. 5.88 g (0.02 mole) of 3,3′,4,4′-biphenyl-tetracarboxylic dianhydride (BPDA) and 15 g of NMP were fed in the first flask accompanied with a stir bar and then stirred to dissolve. Subsequently, the mixture in the first flask was added to the above reactor that the nitrogen gas was continuously charged and stirred to carry out the reaction for one hour. 17.44 g (0.08 mole) of pyromellitic dianhydride (PMDA) and 30 g of NMP were fed in the second flask and then stirred to dissolve. Subsequently, the mixture in the second flask was added to the above reactor that the nitrogen gas was continuously charged and stirred to carry out the reaction for one hour. Afterward, the reaction was carried out at a temperature of 15° C. for further four hours to obtain the polyamic acid (PAA2-1). 0.5 g of the obtained polyamic acid dissolved in 100 ml of NMP, and at a temperature of 25° C., was measured the intrinsic viscosity (IV) as 0.75 dl/g and the glass transition temperature (Tg) after imidization as 338° C.

According to the ingredients and their amount listed in Table 2, Polyamic Acids (PAA) 2-2 and 2-3 were synthesized by the analogous procedures and measured the intrinsic viscosity (IV) and the glass transition temperature (Tg) after imidization shown in Table 2 as well.

TABLE 2

| | PAA 2-1 | PAA 2-2 | PAA 2-3 |
|---|---|---|---|
| BPDA (mole) | 0.2 | 0.2 | 0.4 |
| PMDA (mole) | 0.8 | 0.8 | 0.6 |
| PDA (mole) | 0.9 | 0.8 | 0.9 |
| ODA (mole) | 0.1 | 0.2 | 0.1 |
| Intrinsic Viscosity | 0.75 | 0.87 | 0.77 |
| (IV) (dl/g) | | | |
| Tg (° C.) | 338 | 321 | 325 |

(c) Synthesis of Polyamic Acid-3

Into a four-neck bottle reactor equipped with a stirrer and a nitrogen gas conduit under the flow rate of nitrogen gas of 20 cc/min, 41 g (0.1 mole) of 2,2-bis[4-(4-aminophenoxy)phenyl]propane (BAPP) was placed and dissolved in N-methylpyrrolidone (NMP). After 15 minutes, 2.94 g (0.01 mole) of 3,3′,4,4′-biphenyltetracarboxylic dianhydride (BPDA) and 15 g of NMP were fed in the first flask accompanied with a stir bar and then stirred to dissolve. Subsequently, the mixture in the first flask was added to the above reactor that the nitrogen gas was continuously charged and stirred to carry out the reaction for one hour. 22.54 g (0.07 mole) of 3,3′,4,4′-benzophenonetetracarboxylic dianhydride (BTDA) and 15 g of NMP were fed in the second flask and then stirred to dissolve. Subsequently, the mixture in the second flask was added to the above reactor that the nitrogen gas was continuously charged and stirred to carry out the reaction for one hour. 6.2 g (0.02 mole) of 4,4′-oxydiphthalic anhydride (ODPA) and 30 g of NMP were fed in the third flask and then stirred to dissolve. Subsequently, the mixture in the third flask was added to the above reactor that the nitrogen gas was continuously charged and stirred to carry out the reaction for one hour. Afterward, the reaction was carried out at a temperature of 15° C. for further four hours to obtain the polyamic acid (PAA 3-1). 0.5 g of the obtained polyamic acid dissolved in 100 ml of NMP, and at a temperature of 25° C., was measured the intrinsic viscosity (IV) as 0.95 dl/g and the glass transition temperature (Tg) after imidization as 223° C.

According to the ingredients and their amount listed in Table 3, Polyamic Acids 3-2, 3-3, 3-4 and 3-5 were synthesized by the analogous procedures and measured the intrinsic viscosity (IV) and the glass transition temperature (Tg) after imidization shown in Table 3 as well.

TABLE 3

| | PAA 3-1 | PAA 3-2 | PAA 3-3 | PAA 3-4 | PAA 3-5 | PAA 3-6 | PAA 3-7 |
|---|---|---|---|---|---|---|---|
| BPDA | 0.01 | 0.01 | 0.01 | 0.01 | 0.01 | 0.01 | 0.01 |
| BTDA | 0.07 | 0.07 | 0.07 | 0.07 | 0.07 | 0.07 | 0.07 |
| ODPA | 0.02 | 0.02 | 0.02 | 0.02 | | 0.02 | 0.02 |
| DSDA | | | | | 0.02 | | |
| ODA | | | | | | 0.02 | 0.01 |
| BAPP | 0.01 | | | | | 0.08 | 0.09 |
| BAPB | | 0.01 | | | | | |
| BAPS | | | 0.01 | | | | |
| TPE-R | | | | 0.01 | | | |
| APB | | | | | 0.01 | | |
| Intrinsic | 0.95 | 0.77 | 0.87 | 0.79 | 0.83 | 0.88 | 0.74 |
| Viscosity | | | | | | | |
| (IV) | | | | | | | |
| (dl/g) | | | | | | | |
| Tg (° C.) | 223 | 243 | 229 | 225 | 217 | 236 | 225 |

In Table 3,
BPDA represents 3,3′,4,4′-biphenyltetracarboxylic dianhydride;
BTDA represents 3,3′,4,4′-benzophenonetetracarboxylic dianhydride;
ODPA represents 4,4′-oxydiphthalic anhydride;
DSDA represents 3,3′,4,4′-diphenylsulfonetetracarboxylic dianhydride;
ODA represents 4,4′-oxydianiline;
BAPP represents 2,2-bis[4-(4-aminophenoxy)phenyl]propane;
BAPB represents 4,4′-bis(4-aminophenoxy)-3,3′-dihydroxybiphenyl;
BAPS represents bis[4-(4-aminophenoxy)phenyl]sulfone;
TPE-R represents 1,3-bis(4-aminophenoxy)benzene; and
APB represents1,3-bis(3-aminophenoxy)benzene.

### Working Examples 1 to 16 and Comparative Examples 1 to 6

According to ingredients listed in Table 4 and Table 5, the polyamic acid resin 1 obtained from the above synthesis examples was evenly applied on a copper foil with the thickness of 18 μm by a wire rod, and the thickness of the applied polyamic acid resin 1 was 3 μm. Into an oven, the copper foil was heated at a temperature of 120° C. for 3 minutes and 180° C. for 5 minutes to remove a solvent. The dried copper foil applied with the polyamic acid was taken out on which the polyamic acid resin 2 was then applied with the thickness of 17 μm. Subsequently, into an oven, the copper foil was heated at a temperature of 120° C. for 3 minutes and 180° C. for 7 minutes to remove a solvent. The applied copper foil was taken out on which the polyamic acid resin 3 was then applied with the thickness of 3 μm. Subsequently, into an oven, the copper foil was heated at a temperature of 120° C. for 3 minutes and 180° C. for 5 minutes to remove a solvent. The obtained copper foil was put into a nitrogen gas oven at a temperature of 180° C. for 1 hour, 220° C. for 1 hour, 300° C. for 0.6 hour, and 350° C. for 0.5 hour to subject the polyamic acids to imidization reaction. After cooling, the copper foil was taken out and pressed with another copper foil under a temperature of 340° C. and a pressure of 100 Kgf by using a flat pressing machine in batch or a roll calendar in continuity to produce a two-side copper-foil-pressed flexible printed circuit board. The structure of the flexible board was copper foil/polyimide 1 (280° C.<Tg<300° C. )/polyimide 2 (300° C.<Tg<350° C.)/polyimide 3 (190° C.<Tg<280° C.)/copper foil.

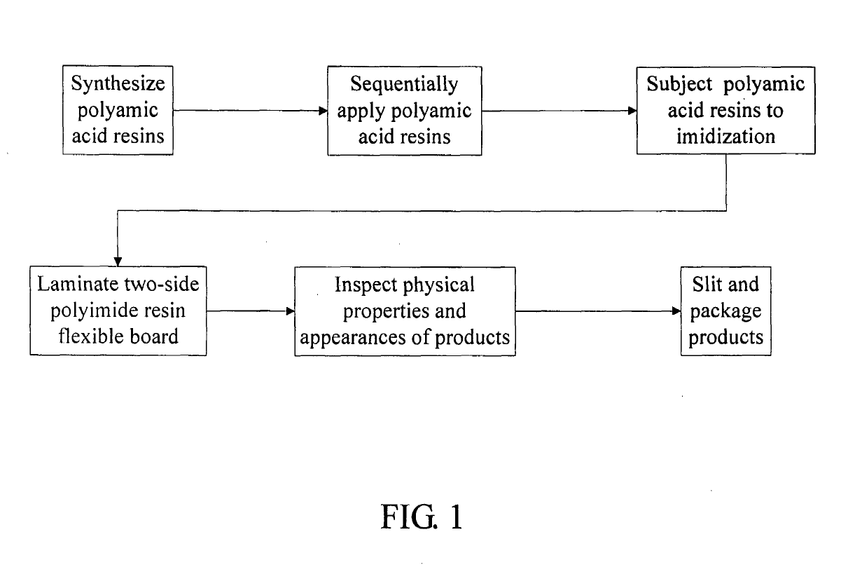

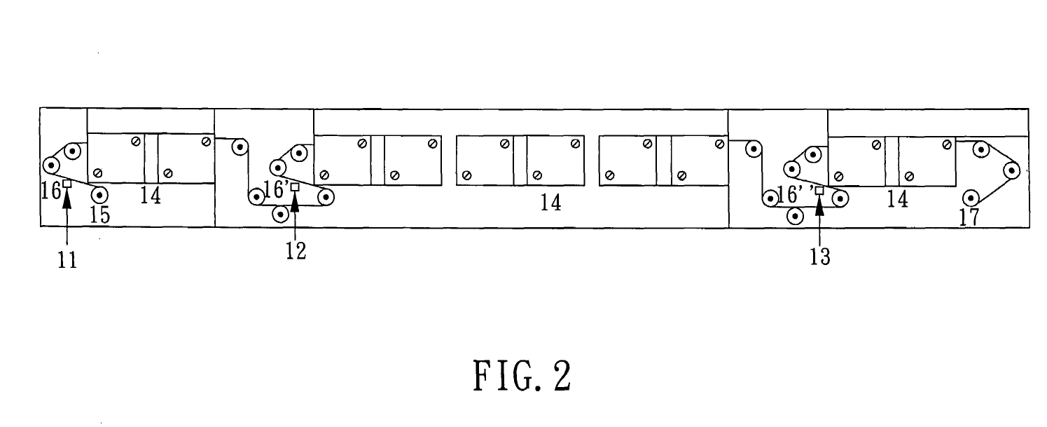

Generally, the two-side copper-foil-pressed flexible printed circuit board could be produced as a procedure shown in FIG. 1. Various polyamic acid resins were synthesized, sequentially applied, and subjected to imidization into polyimide. Afterwards, the polyimide-resin-containing flexible board was laminated with a copper foil by pressing. The flexible board was subsequently inspected physical properties and appearances and then slit and packaged. The foregoing flexible board could be produced by using equipments shown in FIG. 2 to FIG. 4. Firstly, the polyamic acid resins were applied by utilizing the application equipment shown in FIG. 2. The copper foil was delivered to the application equipment by a feeding roller 15; applied with polyamic acid resin 1 at location 11 by an applicator tip 16 and passed through an oven 14 to conduct the first stage of heating and removing a solvent; then applied with polyamic acid resin 2 at location 12 by an applicator tip 16′ and passed through an oven 14′ to conduct the second stage of heating and removing a solvent; finally applied with polyamic acid resin 3 at location 13 by an applicator tip 16″ and passed through an oven 14″ to conduct the third stage of heating and removing a solvent; and collected on the other side by a collect roller 17. The copper foil roll applied with three layers of various polyamic acid resins was obtained.

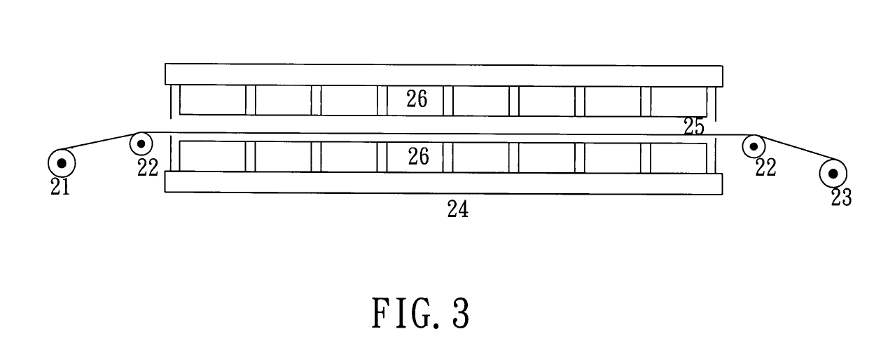

Subsequently, the imidization equipment shown in FIG. 3 was utilized. The foregoing copper foil roll was put on a feeding roller 21; introduced and passed through an oven 24 and a nitrogen gas oven 25 by directive rollers 22, 22 that were individually installed at the inlet and the outlet of the oven 24; subjected to imidization by a heating apparatus 26; and collected on the other side by a collect roller 23. The copper foil roll having three layers of various polyimides was obtained.

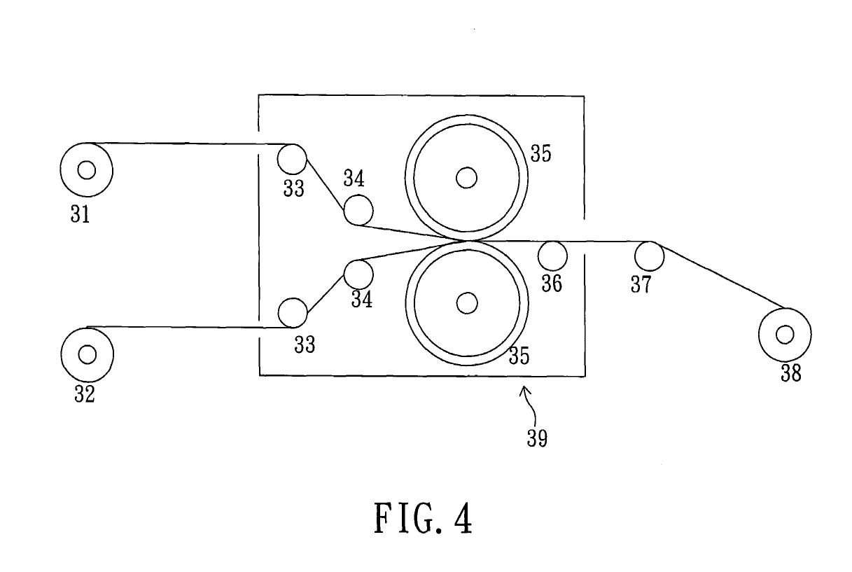

Finally, the pressing equipment shown in FIG. 4 was utilized. The above obtained copper foil roll having three layers of various polyimides was put on a feeding roller 32, and meanwhile another copper foil roll was put on another feeding roller 31. Both copper foil rolls were introduced and passed through a high temperature pressing roller 35 by individual directive rollers 33 and 34; pressed to produce a copper foil roll having two-side copper; and collected at a collect roller 38 through directive rollers 36 and 37. The directive rollers 33, 34 and 36 and the high temperature pressing roller 35 were placed into a nitrogen gas oven 39.

The resultant copper foil was measured the peel strength regulated by IPC-TM650 2.2.9, the coefficient of thermal expansion by thermal gravity analyzer, and dimension stability regulated by IPC-TM650 2.2.4. The results were shown in Tables 4 and 5.

TABLE 4

| | Working Example Number | | | | | | | | |
|---|---|---|---|---|---|---|---|---|---|
| | 1 | 2 | 3 | 4 | 5 | 6 | 7 | 8 | 9 |
| Metal Foil | A | A | A | B | C | A | A | A | A |
| (Copper | | | | | | | | | |
| Foil) | | | | | | | | | |
| 1^{st} Layer of | PAA | PAA | PAA | PAA | PAA | PAA | PAA | PAA | PAA |
| PI (Kind) | 1-1 | 1-1 | 1-1 | 1-1 | 1-1 | 1-2 | 1-3 | 1-1 | 1-1 |
| 1^{st} Layer of | 3 μm | 3 μm | 3 μm | 3 μm | 3 μm | 3 μm | 3 μm | 3 μm | 3 μm |
| PI | | | | | | | | | |
| (Thickness) | | | | | | | | | |
| 2^{nd} Layer | PAA | PAA | PAA | PAA | PAA | PAA | PAA | PAA | PAA |
| of PI | 2-1 | 2-1 | 2-1 | 2-1 | 2-1 | 2-2 | 2-3 | 2-1 | 2-1 |
| (Kind) | | | | | | | | | |
| 2^{nd} Layer | 19 μm | 14 μm | 9 μm | 19 μm | 19 μm | 19 μm | 19 μm | 19 μm | 19 μm |
| of PI | | | | | | | | | |
| (Thickness) | | | | | | | | | |
| 3^{rd} Layer of | PAA | PAA | PAA | PAA | PAA | PAA | PAA | PAA | PAA |
| PI (Kind) | 3-1 | 3-1 | 3-1 | 3-1 | 3-1 | 3-1 | 3-1 | 3-2 | 3-3 |
| 3^{rd} Layer of | 3 μm | 3 μm | 3 μm | 3 μm | 3 μm | 3 μm | 3 μm | 3 μm | 3 μm |
| PI | | | | | | | | | |
| (Thickness) | | | | | | | | | |
| Peel | 1.3 | 1.3 | 1.2 | 1.1 | 1.6 | 1.3 | 1.1 | 1.2 | 1.1 |
| Strength | | | | | | | | | |
| (kgf/cm) | | | | | | | | | |
| Applied | | | | | | | | | |
| Side | | | | | | | | | |
| Peel | 1.2 | 1.3 | 1.2 | 1.1 | 1.4 | 1.3 | 1.3 | 1.2 | 1.2 |
| Strength | | | | | | | | | |
| (kgf/cm) | | | | | | | | | |
| Pressed | | | | | | | | | |
| Side | | | | | | | | | |
| Dimension | −0.03 | −0.05 | −0.07 | −0.04 | −0.02 | −0.04 | −0.05 | −0.03 | −0.06 |
| stability | | | | | | | | | |
| (%, MD) | | | | | | | | | |
| Dimension | −0.05 | −0.03 | −0.05 | −0.06 | −0.05 | −0.01 | −0.06 | −0.01 | −0.05 |
| stability | | | | | | | | | |
| (%, TD) | | | | | | | | | |

| | Working Example Number | | | | | | |
|---|---|---|---|---|---|---|---|
| | 10 | 11 | 12 | 13 | 14 | 15 | 16 |
| Metal Foil | A | A | A | A | A | A | A |
| (Copper | | | | | | | |
| Foil) | | | | | | | |
| 1^{st} Layer of | PAA | PAA | PAA | PAA | PAA | Polyamic | Polyamic |
| PI (Kind) | 1-1 | 1-1 | 1-1 | 1-1 | 1-1 | Acid 1-1 | Acid 1-1 |
| 1^{st} Layer of | 3 μm | 3 μm | 2 μm | 5 μm | 7 μm | 2 μm | 5 μm |
| PI | | | | | | | |
| (Thickness) | | | | | | | |
| 2^{nd} Layer | PAA | PAA | PAA | PAA | PAA | Polyamic | Polyamic |
| of PI | 2-1 | 2-1 | 2-1 | 2-1 | 2-1 | Acid 2-1 | Acid 2-1 |
| (Kind) | | | | | | | |
| 2^{nd} Layer | 19 μm | 19 μm | 46 μm | 40 μm | 36 μm | 6 μm | 10 μm |
| of PI | | | | | | | |
| (Thickness) | | | | | | | |
| 3^{rd} Layer of | PAA | PAA | PAA | PAA | PAA | Polyamic | Polyamic |
| PI (Kind) | 3-4 | 3-5 | 3-3 | 3-4 | 3-5 | Acid 3-3 | Acid 3-4 |
| 3^{rd} Layer of | 3 μm | 3 μm | 2 μm | 5 μm | 7 μm | 2 μm | 5 μm |
| PI | | | | | | | |
| (Thickness) | | | | | | | |
| Peel | 1.3 | 1.2 | 1.1 | 1.4 | 1.3 | 1.1 | 1.4 |
| Strength | | | | | | | |
| (kgf/cm) | | | | | | | |
| Applied | | | | | | | |
| Side | | | | | | | |
| Peel | 1.4 | 1.2 | 1.0 | 1.4 | 1.4 | 1.1 | 1.4 |
| Strength | | | | | | | |
| (kgf/cm) | | | | | | | |
| Pressed | | | | | | | |
| Side | | | | | | | |
| Dimension | −0.03 | −0.04 | −0.01 | −0.03 | −0.04 | −0.06 | −0.03 |
| stability | | | | | | | |
| (%, MD) | | | | | | | |
| Dimension | −0.02 | −0.04 | −0.02 | −0.02 | −0.03 | −0.05 | −0.05 |
| stability | | | | | | | |
| (%, TD) | | | | | | | |

PAA: Polyamic acid; PI: Polyimide;
Copper Foil A: Electrolytic copper foil ⅓ OZ ED manufactured by Chang Chun Plastic Co., Ltd., Taiwan, R.O.C.
Copper Foil B: Electrolytic copper foil ⅓ OZ ED manufactured by Furukawa Electric Co., Ltd., Japan.
Copper Foil C: Rolled copper foil ½ OZ ED manufactured by JE Co. Ltd.

TABLE 5

| | Example | | | | | | | |
|---|---|---|---|---|---|---|---|---|
| | Number | | Comparative Example Number | | | | | |
| | 17 | 18 | 1 | 2 | 3 | 4 | 5 | 6 |
| Metal Foil | A | A | A | A | A | A | A | A |
| (Copper | | | | | | | | |
| Foil) | | | | | | | | |
| 1^{st} Layer of | PAA | PAA | PAA | PAA | PAA | PAA | PAA | PAA |
| PI (Kind) | 1-1 | 1-1 | 1-1 | 2-1 | 3-1 | 1-1 | 1-1 | 3-1 |
| 1^{st} Layer of | 3 μm | 3 μm | 25 μm | 25 μm | 25 μm | 3 μm | 3 μm | 3 μm |
| PI | | | | | | | | |
| (Thickness) | | | | | | | | |
| 2^{nd} Layer | PAA | PAA | | | | PAA | PAA | PAA |
| of PI | 2-1 | 2-1 | | | | 2-1 | 2-1 | 2-1 |
| (Kind) | | | | | | | | |
| 2^{nd} Layer | 19 μm | 19 μm | | | | 22 μm | 19 μm | 19 μm |
| of PI | | | | | | | | |
| (Thickness) | | | | | | | | |
| 3^{rd} Layer of | PAA | PAA | | | | | PAA | PAA |
| PI (Kind) | 3-6 | 3-7 | | | | | 1-1 | 3-1 |
| 3^{rd} Layer of | 3 μm | 3 μm | | | | | 3 μm | 3 μm |
| PI | | | | | | | | |
| (Thickness) | | | | | | | | |
| Peel | 1.2 | 1.2 | 1.5 | 0.8 | 1.6 | 1.2 | 1.3 | 1.3 |
| Strength | | | | | | | | |
| (kgf/cm) | | | | | | | | |
| Applied | | | | | | | | |
| Side | | | | | | | | |
| Peel | 1.1 | 1.2 | Can't | Can't | 1.7 | Can't | Can't | 1.2 |
| Strength | | | Press | Press | | Press | Press | |
| (kgf/cm) | | | | | | | | |
| Pressed | | | | | | | | |
| Side | | | | | | | | |
| Dimension | −0.02 | −0.03 | −0.007 | −0.05 | −0.23 | −0.01 | −0.01 | −0.15 |
| stability | | | | | | | | |
| (%, MD) | | | | | | | | |
| Dimension | −0.02 | −0.04 | −0.008 | −0.03 | −0.27 | −0.03 | −0.01 | −0.17 |
| stability | | | | | | | | |
| (%, TD) | | | | | | | | |

PAA: Polyamic acid; PI: Polyimide;
Copper Foil A: Electrolytic copper foil ⅓ OZ ED manufactured by Chang Chun Plastic Co., Ltd., Taiwan, R.O.C.

According to the present invention, the polyamic acid resins each having different glass transition temperature (Tg) after imidization were utilized. The polyamic acid resin having Tg of from 280 to 300° C. after imidization with high adhesion was firstly applied on the copper foil, and then the polyamic acid resin having Tg of 300 to 350° C. after imidization with an excellent mechanical property was applied as a support layer, and finally the polyamic acid resin having comparatively low Tg of from 190 to 280° C. after imidization with high adhesion was applied. Subsequently, the copper foil was pressed with another copper foil by using a high temperature roller or a pressing machine. At the same time, the polyamic acids conducted imidization reaction, and thus a two-side printed circuit flexible board with heat stability and dimension stability could be obtained.

What is claimed is:

1. A polyimide composite flexible board, which is made by sequentially laminating a metal foil, a polyimide thin layer having a glass transition temperature of from 280 to 300° C., a polyimide thin layer having a glass transition temperature of from 300 to 350° C., a polyimide thin layer having a glass transition temperature of from 190 to 280° C., and a metal foil.

2. The polyimide composite flexible board according to claim 1, wherein said first polyimide having a glass transition temperature of from 280 to 300° C. is obtained by reacting a diamine monomer containing one benzene ring and a dianhydride monomer containing one benzene ring with other diamine monomer and other dianhydride monomer, under the conditions that the mole ratio of total diamine monomer/total dianhydride monomer ranges from 0.5 to 2.0, and the mole ratio of diamine monomer containing one benzene ring/other diamine monomer ranges from 60/40 to 20/80, and the mole ratio of dianhydride monomer containing one benzene ring/other dianhydride monomer ranges from 40/60 to 20/80.

3. The polyimide composite flexible board according to claim 1, wherein said second polyimide having a glass transition temperature of from 300 to 350° C. is obtained by reacting a diamine monomer containing one benzene ring and a dianhydride monomer containing one benzene ring with other diamine monomer and other dianhydride monomer, under the conditions that the mole ratio of total diamine monomer/total dianhydride monomer ranges from 0.5 to 2.0, and the mole ratio of diamine monomer containing one benzene ring/other diamine monomer ranges from 95/5 to 80/20, and the mole ratio of dianhydride monomer containing one benzene ring/other dianhydride monomer ranges from 80/20 to 60/40.

4. The polyimide composite flexible board according to claim 1, wherein said third polyimide having a glass transition temperature of from 190 to 280° C. is obtained by reacting a diamine monomer containing at least two benzene rings and a dianhydride monomer containing two benzene rings with other dianhydride monomer, under the conditions that the mole ratio of total diamine monomer/total dianhydride monomer ranges from 0.5 to 2.0, and the molar ratio of diamine monomer containing at least two benzene rings/other diamine monomer ranges from 60/40 to 100/0.

5. The polyimide composite flexible board according to claim 1, wherein the thickness of said metal foil ranges from 12 μm to 70 μm.

6. The polyimide composite flexible board according to claim 5, wherein said metal foil is a copper foil.

7. The polyimide composite flexible board according to claim 1, wherein the thicknesses of said first polyimide thin layer, said second polyimide thin layer, and said third polyimide thin layer individually satisfy the following conditions,
$$\frac{3}{100} \leq \frac{The Thickness of the Frist Polyimide Thin Layer}{The Total Thickness of Three Layers of Polyimides} \leq \frac{35}{100}$$
$$\frac{30}{100} \leq \frac{The Thickness of the Second Polyimide Thin Layer}{The Total Thickness of Three Layers of Polyimides} \leq \frac{94}{100}$$
$$\frac{3}{100} \leq \frac{The Thickness of the Third Polyimide Thin Layer}{The Total Thickness of Three Layers of Polyimides} \leq \frac{35}{100} .$$

8. A process for preparing a polyimide composite flexible board, which comprises the following steps of:
(a) applying the first polyamic acid resin having a glass transition temperature of from 280 to 300° C. after imidization on a metal foil, which is subsequently in an oven heated at a temperature of 90 to 140° C. and then of 150 to 200° C. to remove a solvent;
(b) taking out the polyamic-acid-applied metal foil that has removed the solvent, following by applying the second polyamic acid resin having a glass transition temperature of from 300 to 350° C. after imidization on the first polyamic acid layer, which is subsequently in an oven heated at a temperature of 90 to 140° C. and then of 150 to 200° C. to remove a solvent;
(c) taking out the applied metal foil, following by applying the third polyamic acid resin having a glass transition temperature of from 190 to 280° C. after imidization on the second polyamic acid layer, which is subsequently in an oven heated at a temperature of 90 to 140° C. and then of 150 to 200° C. to remove a solvent;
(d) into a nitrogen gas oven putting the obtained metal foil with three layers of polyamic acids, which is then sequentially heated at a temperature of 160 to 190° C., 190 to 240° C., 270 to 320° C. and 330 to 370° C. to subject the polyamic acids to imidization; and
(e) taking out the polyimide-containing metal foil after cooling, which is then laminated with another metal foil under a temperature of from 320 to 370° C. and a pressure of from 10 to 200 Kgf by using a pressing machine or a roll calender to produce a two-side polyimide composite flexible board.

9. The process according claim 8, wherein said polyamic acid resin is obtained by reacting diamine of the following formula (I),
H₂N—R₁—NH₂ (I)
[wherein R₁ is a covalent bond; phenylene (-Ph-); -Ph-X-Ph- wherein X represents a covalent bond, C₁₋₄ alkylene which may be substituted with a halogen(s), —O-Ph-O—, —O—, —CO—, —S—, —SO—, or —SO2—; C₂₋₁₄ aliphatic hydrocarbon group; C₄₋₃₀ aliphatic cyclic hydrocarbon group; C₆₋₃₀ aromatic hydrocarbon group; or -Ph-O—R₂—O-Ph- wherein R₂ represents -Ph- or -Ph-X-Ph-, and X represents a covalent bond, C₁₋₄ alkylene which may be substituted with a halogen(s), —O-Ph-O—, —O—, —CO—, —S—, —SO—, or —SO₂—];
with dianhydride of the following formula (II), 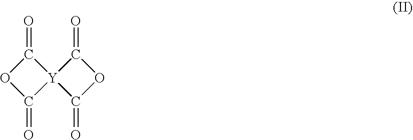
[wherein Y is a aliphatic group containing 2 to 12 carbon atoms; a cycloaliphatic group containing 4 to 8 carbon atoms; monocyclic or polycyclic C₆₋₁₄ aryl; >Ph-X-Ph< wherein X represents a covalent bond, C₁₋₄ alkylene which may be substituted with a halogen(s), —O-Ph-O—, —O—, —CO—, —S—, —SO—, or —SO₂—].

10. The process according claim 8, wherein said first polyamic acid resin having a glass transition temperature of from 280 to 300° C. after imidization is obtained by reacting a diamine monomer containing one benzene ring and a dianhydride monomer containing one benzene ring with other diamine monomer and other dianhydride monomer, under the conditions that the mole ratio of total diamine monomer/total dianhydride monomer ranges from 0.5 to 2.0, and the mole ratio of diamine monomer containing one benzene ring/other diamine monomer ranges from 60/40 to 20/80, and the mole ratio of dianhydride monomer containing one benzene ring/other dianhydride monomer ranges from 40/60 to 20/80.

11. The process according claim 8, wherein said second polyamic acid resin having a glass transition temperature of from 300 to 350° C. after imidization is obtained by reacting a diamine monomer containing one benzene ring and a dianhydride monomer containing one benzene ring with other diamine monomer and other dianhydride monomer, under the conditions that the mole ratio of total diamine monomer/total dianhydride monomer ranges from 0.5 to 2.0, and the mole ratio of diamine monomer containing one benzene ring/other diamine monomer ranges from 95/5 to 80/20, and the mole ratio of dianhydride monomer containing one benzene ring/other dianhydride monomer ranges from 80/20 to 60/40.

12. The process according claim 8, wherein said third polyamic acid resin having a glass transition temperature of from 190 to 280° C. after imidization is obtained by reacting a diamine monomer containing at least two benzene rings and a dianhydride monomer containing two benzene rings with other dianhydride monomer, under the conditions that the mole ratio of total diamine monomer/total dianhydride monomer ranges from 0.5 to 2.0, and the mole ratio of diamine monomer containing at least two benzene rings/other diamine monomer ranges from 60/40 to 100/0.

13. The process according claim 8, wherein the thickness of said metal foil ranges from 12 μm to 70 μm.

14. The process according claim 13, wherein said metal foil is a copper foil.

15. The process according claim 8, wherein after said first polyamic acid resin, said second polyamic acid resin, and said third polyamic acid resin are subjected to imidization, the thicknesses of the first polyimide thin layer, the second polyimide thin layer, and the third polyimide thin layer individually satisfy the following conditions,
$$\frac{3}{100} \leq \frac{The Thickness of the Frist Polyimide Thin Layer}{The Total Thickness of Three Layers of Polyimides} \leq \frac{35}{100}$$
$$\frac{30}{100} \leq \frac{The Thickness of the Second Polyimide Thin Layer}{The Total Thickness of Three Layers of Polyimides} \leq \frac{94}{100}$$
$$\frac{3}{100} \leq \frac{The Thickness of the Third Polyimide Thin Layer}{The Total Thickness of Three Layers of Polyimides} \leq \frac{35}{100} .$$
